(19) United States
(12) Patent Application Publication
(10) Pub. No.: US 2025/0337918 A1
(43) Pub. Date: Oct. 30, 2025

(54) MULTIMODAL PREDICTION

(71) Applicant: GOOGLE LLC, Mountain View, CA (US)

(72) Inventors: Cheng Chen, Milpitas, CA (US); Xiang Li, Saratoga, CA (US); Jingning Han, Santa Clara, CA (US)

(21) Appl. No.: 19/192,467

(22) Filed: Apr. 29, 2025

Related U.S. Application Data
(60) Provisional application No. 63/639,852, filed on Apr. 29, 2024.

(51) Int. Cl. H04N 19/159; H04N 19/176; H04N 19/196

(52) U.S. Cl. CPC H04N 19/159; H04N 19/176; H04N 19/196

(57) ABSTRACT

The present disclosure provides a method and non-transitory computer readable medium for predicting pixels of a current block. The method includes classifying pixels of a reference block into a first plurality of groups and classifying pixels of a current block adjacent area into a second plurality of groups. A first model for transforming a first group of the first plurality of groups is derived based on pixels in a first group of the first plurality of groups and pixels in a first group of the second plurality of groups. A prediction block for the current block is generated by applying the first model to pixels in the first group of the first plurality of groups. A compressed bitstream encoded by an encoder or decodable by a decoder using the prediction method is also provided.

### CROSS-REFERENCE TO RELATED APPLICATION(S)

This disclosure claims the benefit of U.S. Provisional Patent Application No. 63/639,852 filed Apr. 29, 2024, the disclosure of which is incorporated by reference herein in its entirety.

### BACKGROUND

Digital images and video can be used, for example, on the internet, for remote business meetings via video conferencing, high-definition video entertainment, video advertisements, or sharing of user-generated content. Due to the large amount of data involved in transferring and processing image and video data, high-performance compression may be advantageous for transmission and storage. Accordingly, it would be advantageous to provide high-resolution image and video transmitted over communications channels having limited bandwidth.

### SUMMARY

This application relates to encoding and decoding of image data, video stream data, or both for transmission, storage, or both. Disclosed herein are aspects of systems, methods, and apparatuses for encoding and decoding using multimodal prediction.

An aspect is a method for predicting pixels of a current block. The method includes classifying pixels of a reference block into a first plurality of groups, classifying pixels of a current block adjacent area into a second plurality of groups, deriving a first model for transforming a first group of the first plurality of groups based on pixels in a first group of the first plurality of groups and pixels in a first group of the second plurality of groups, and generating a prediction block for the current block, wherein generating the prediction block includes applying the first model to pixels in the first group of the first plurality of groups.

An aspect is a non-transitory computer-readable medium storing instructions, that when executed by a computer, cause the computer to predict pixels of a current block by classifying pixels of a reference block into a first plurality of groups, classifying pixels of a current block adjacent area into a second plurality of groups, deriving a first model for transforming a first group of the first plurality of groups based on pixels in a first group of the first plurality of groups and pixels in a first group of the second plurality of groups, and generating a prediction block for the current block, wherein generating the prediction block includes applying the first model to pixels in the first group of the first plurality of groups.

An aspect is a non-transitory computer-readable medium storing a compressed bitstream encoded by an encoder or decodable by a decoder that predicts pixels of a current block encoded in the compressed bitstream by: classifying pixels of a reference block into a first plurality of groups, classifying pixels of a current block adjacent area into a second plurality of groups, deriving a first model for transforming a first group of the first plurality of groups based on pixels in a first group of the first plurality of groups and pixels in a first group of the second plurality of groups, and generating a prediction block for the current block, wherein generating the prediction block includes applying the first model to pixels in the first group of the first plurality of groups.

Variations in these and other aspects will be described in additional detail hereafter.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram illustrating an intra block copy mode in accordance with implementations of this disclosure.

FIG. 7 is a block diagram illustrating adjacent areas in accordance with implementations of this disclosure.

FIG. 8 is a block diagram illustrating an example of pixel values for which multimodal prediction may be used in accordance with implementations of this disclosure.

FIG. 9 is a flow diagram of an example technique for predicting pixels in accordance with implementations of this disclosure.

### DETAILED DESCRIPTION

Compression schemes related to coding video streams may include breaking images into blocks and generating a digital video output bitstream using one or more techniques to limit the number of bits included in the output. A received bitstream can be decoded to re-create the blocks and the source images from the limited information. Encoding a video stream, or a portion thereof, such as a frame or a block, can include using temporal or spatial similarities in the video stream to improve coding efficiency. For example, a current block of a video stream may be encoded based on identifying a difference (residual) between a prediction based on previously decoded pixel values and those in the current block. In this way, the residual and parameters used to generate it need be added to the bitstream instead of including the entirety of the current block. This technique may be referred to as inter or intra prediction (depending on where the previously decoded pixel values are obtained from).

One technique for intra prediction is to utilize a block of previously decoded pixels in the same frame to form a prediction block for a current block being decoded. Such a technique may be referred to as an intra block copy mode. Such a mode may be more effective for predicting blocks of screen content where repeated patterns of pixels may occur frequently, such as characters, sharp edges, and the like.

An intra block copy mode may be particularly effective when there exists previously decoded content includes a block of pixels that matches both the shape and pixel values of the current block of pixels (e.g., if a prior block includes pixels depicting a red “X” and the current block includes pixels depicting the same red “X”). The intra block copy mode may be less effective where there is a match in shape but differences in color (e.g., if a prior block includes pixels depicting a red “X” and the current block includes pixels depicting the same “X” but in a different color or texture).

Implementations of this disclosure solve problems such as these by utilizing multimodal prediction which includes classifying pixels of the reference block, pixels of an area adjacent to the reference block, and pixels of an area adjacent to the current block into respective groups, deriving a model for transforming pixels of the reference block based on differences between group(s) in the area adjacent to the reference block and respective group(s) in the area adjacent to the current block, and applying the model to generate a prediction block. Such a prediction block may be able to more closely approximate the pixel values in the current block using the model derived based on the adjacent areas. This multimodal prediction process may improve compression as a result of an improved prediction while limiting the inclusion of additional side information in the bitstream because the classification, model derivation, and model application are performed independently by encoder and decoder using a common process. Thus, only limited signaling information may be needed in the compressed bitstream (e.g., such as a binary indication to enable or disable multimodal prediction for a block predicted using intra block copy).

Implementations of multimodal prediction will now be further described.

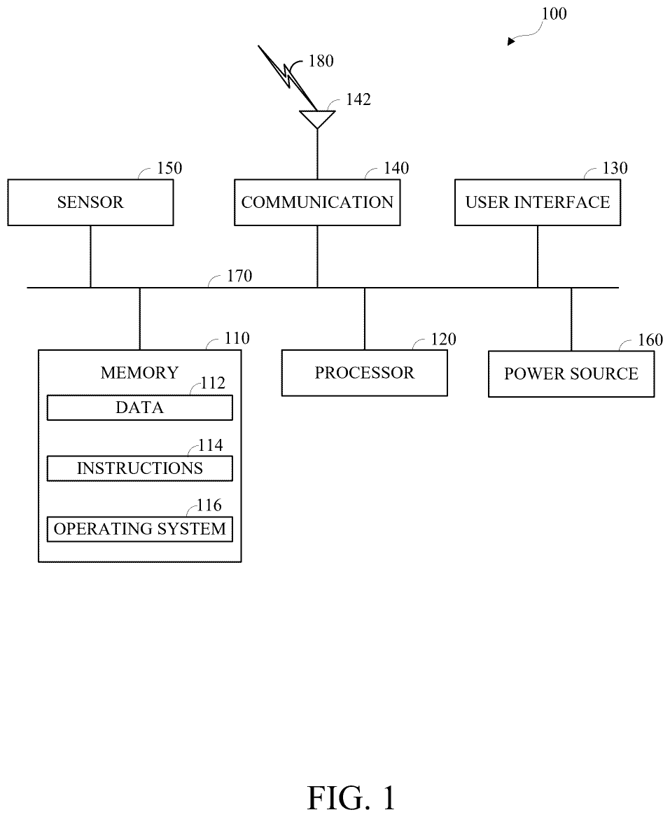

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input video data, encoded video data, decoded video data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

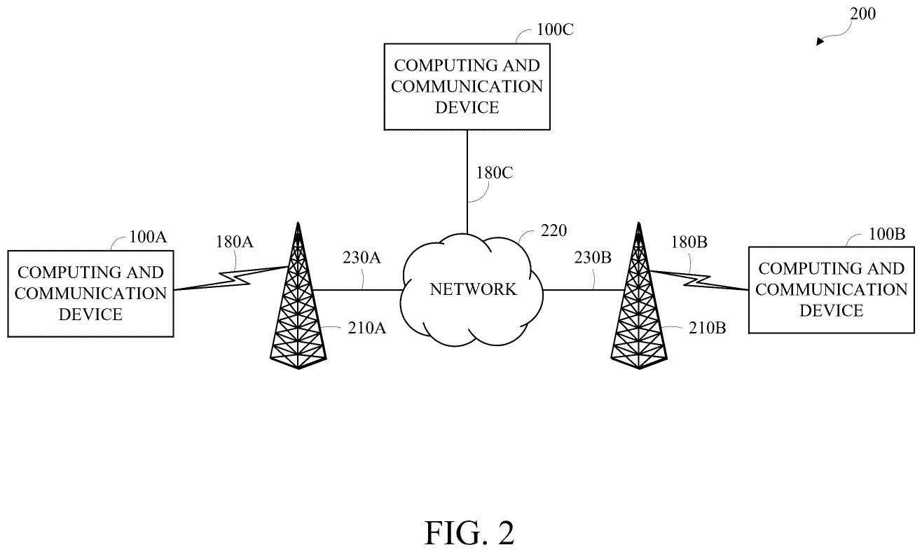

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof video data and one or both of the computing and communication device 100A and the computing and communication device 100B may receive, decode, process, store, present, or a combination thereof the video data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VoIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communication devices, networks, and access points.

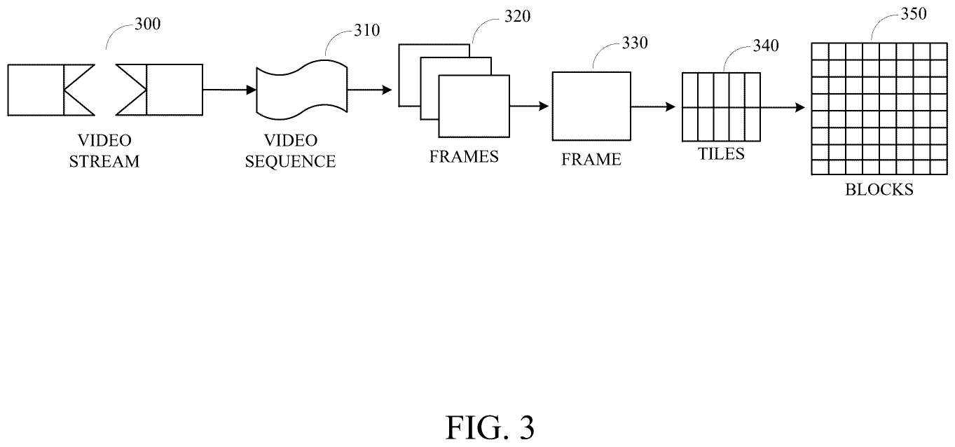

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

A frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. A tile 340 may be a rectangular region of the frame that can be coded independently. Tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

Some implementations may include additional or fewer components than described with respect to FIG. 3. For example, some implementations may not utilize tiles. For example, some implementations may utilize slices or some other intermediate partitioning of a frame instead of tiles. For example, some implementations may utilize different block structures. For example, some implementations may utilize variable block sizes. For example, some implementations may utilize a hierarchical block structure with two or more levels of blocks with different sizes (e.g., in a quad-tree type structure) where different information is coded at different block levels.

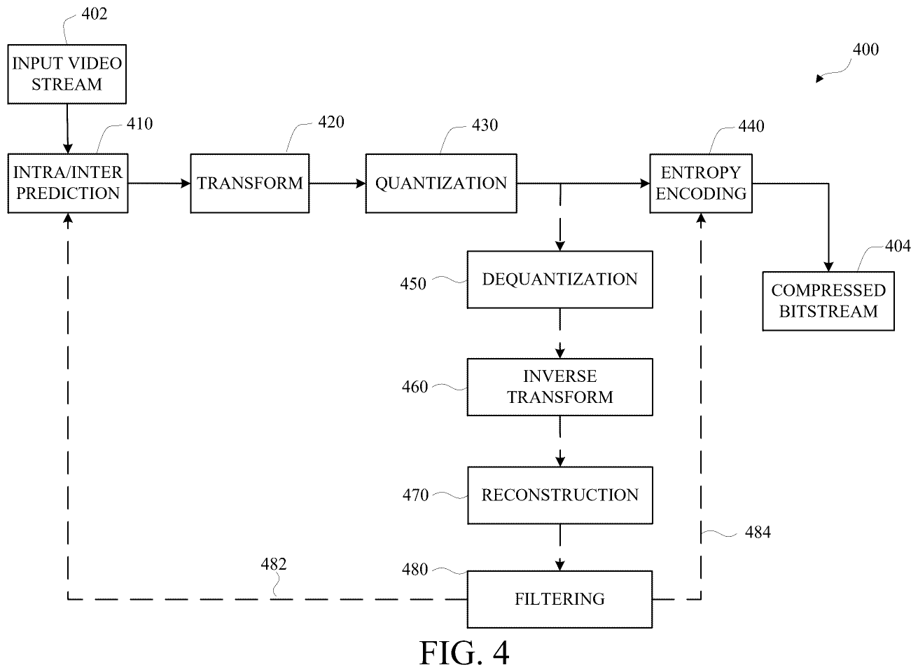

FIG. 4 is a block diagram of an encoder 400 in accordance with implementations of this disclosure. Encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Intra-prediction may include utilizing an intra block copy mode and/or multimodal prediction such as described in more detail elsewhere in this disclosure. Inter-prediction may include generating a prediction block from samples in one or more previously constructed reference frames. Generating a prediction block for a current block in a current frame may include performing motion estimation to generate a motion vector indicating an appropriate reference portion of the reference frame. The motion vector may be generated at a sub-pixel precision. In such a case, interpolation may be utilized to approximate the pixels of the prediction block based on decoded pixels in the reference frame.

The intra/inter prediction unit 410 may subtract the prediction block from the current block (raw block) to produce a residual block. The transform unit 420 may perform a block-based transform, which may include transforming a block of residual pixels into a transform block of transform coefficients in, for example, the frequency domain. The block of pixels used to create a transform block may be the same or different than the blocks used to generate the prediction and residual blocks. For example, a transform block may be a subdivision of a residual block or residual values in a frame may be partitioned using a different block partitioning scheme altogether as compared to the blocks used to produce the residual values. Examples of block-based transforms include the Karhunen-Loeve Transform (KLT), the Discrete Cosine Transform (DCT), the Singular Value Decomposition Transform (SVD), and the Asymmetric Discrete Sine Transform (ADST). In an example, the DCT may include transforming a block into the frequency domain. The DCT may include using transform coefficient values based on spatial frequency, with the lowest frequency (i.e., DC) coefficient at the top-left of the matrix and the highest frequency coefficient at the bottom-right of the matrix. In some implementations,

The quantization unit 430 may convert the transform coefficients into discrete quantized values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the transform block, which may include the type of prediction used, motion vectors, and quantizer values, can be output to the compressed bitstream 404. The compressed bitstream 404 can be formatted using various techniques, such as run-length encoding (RLE) and zero-run coding.

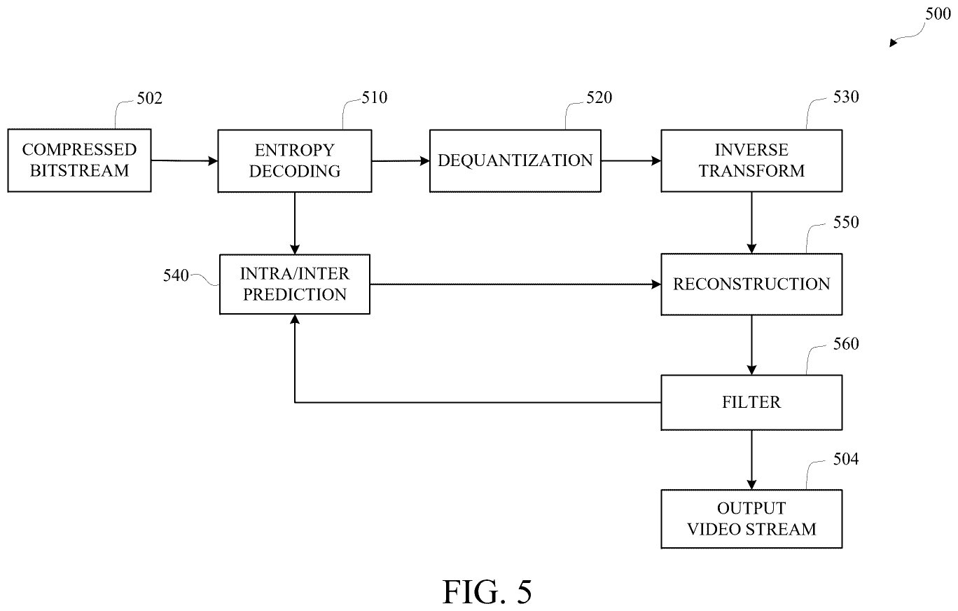

The reconstruction path can be used to maintain prediction synchronization between the encoder 400 and a corresponding decoder, such as the decoder 500 shown in FIG. 5. The reconstruction path may be similar to the decoding process discussed below and may produce an output equivalent to that produced by the decoding process to enable prediction at both the encoder and the decoder to produce the same results. The reconstruction process may include decoding the encoded frame, or a portion thereof, which may include decoding an encoded transform block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. In the event that different block sizes or partitioning schemes are used for prediction and transform, decoded residual values from multiple transform blocks may be utilized when reconstructing a decoded block of pixels using a prediction block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. The reconstructed block may be stored or otherwise made accessible as a reconstructed block, which may be a portion of a reference frame, for encoding another portion of a current frame, another frame, or both, as indicated by the broken line at 482. Coding information, such as deblocking threshold index values, for the frame may be encoded, included in the compressed bitstream 404, or both, as indicated by the broken line at 484.

Other variations of the encoder 400 can be used to encode the compressed bitstream 404. For example, in some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

Other variations of the decoder 500 can be used to decode the compressed bitstream 502.

A video coding standard may specify the requirements to produce a compliant decoder. Such a standard may not specify how to make a video encoder or may provide only certain requirements as to what must be included in a compliant encoder. Instead, an encoder is compliant if it produced a video bitstream that is capable of being decoded by a compliant video decoder. Accordingly, certain tools are implemented to produce the same results in both the encoder and decoder, such as producing the same prediction when performing intra/inter prediction, contexts for entropy coding and decoding an end-of-block position of a transform block.

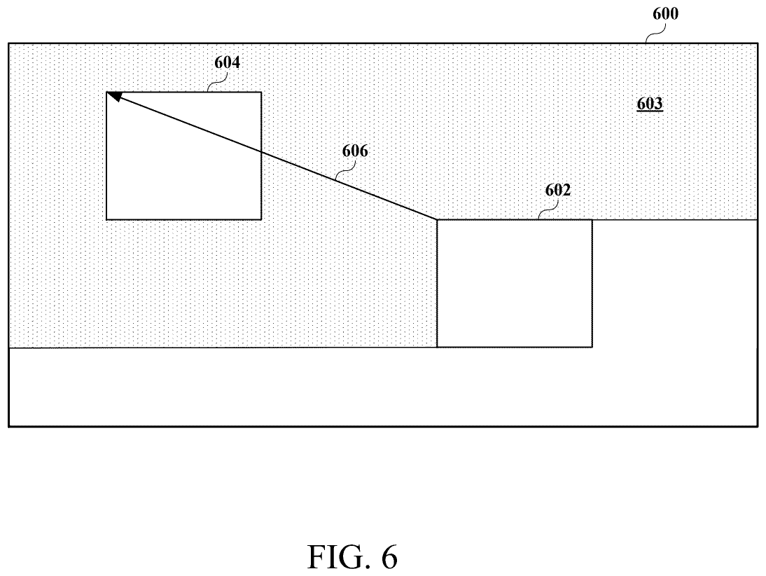

FIG. 6 is a block diagram illustrating an intra block copy mode in accordance with implementations of this disclosure. FIG. 6 illustrates a current frame 600 being coded and a current block 602 within the current frame 600.

In an intra block copy mode, an encoder (e.g., the encoder 400 of FIG. 4) typically searches at least a subset of a reconstructed area 603 of the current frame 600 to identify a reference block (e.g., a reference block 604) that is similar to the current block 602. The reference block 604 is used as a prediction block for the current block 602. A difference (i.e., residual) between the current block 602 and the reference block 604 is encoded in a compressed bitstream (e.g., the compressed bitstream 404 of FIG. 4) along with a block vector (BV), such as a block vector 606. As such, an intra block copy mode can be considered as “motion compensation” within the same frame (e.g., the current frame 600), essentially using a BV instead of a motion vector. The encoder encodes a flag (e.g., an intra block copy flag) indicating that the current block 602 is encoded using the intra block copy mode and also encodes the BV.

When decoding the current block 602, a decoder, such as the decoder 500 of FIG. 5, decodes the intra block copy flag to determine whether the current block 602 is to be decoded using the intra block copy mode. In some implementations, whether intra block copy mode is utilized may be determined contextually or may not be considered at all in at least some circumstances. For example, if inter coding is utilized, it can be inferred that intra block copy mode is not utilized and/or no determination may be made (because inter coding is being used instead of intra coding). If so, the decoder decodes block vector 606 from the compressed bitstream to identify the reference block 604 to obtain the prediction block for the current block 602. A residual block can then be decoded from the compressed bitstream to add to the prediction block to reconstruct the current block 602.

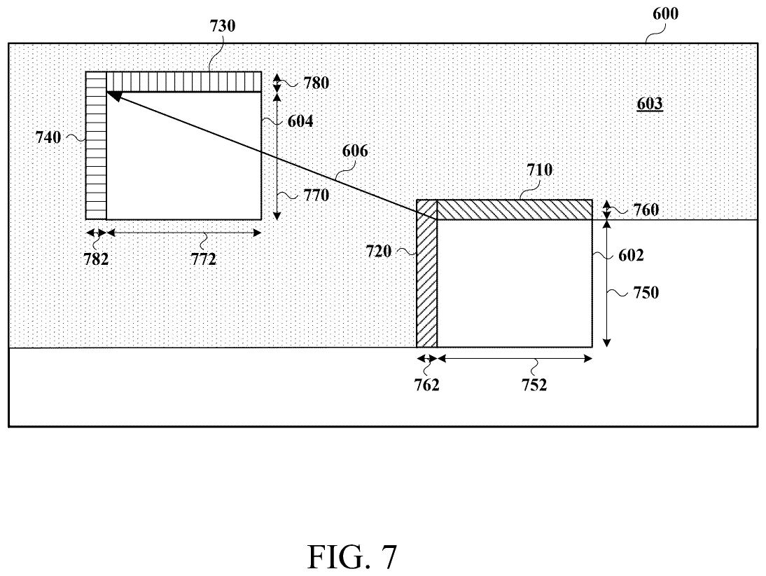

FIG. 7 is a block diagram illustrating adjacent areas in accordance with implementations of this disclosure. FIG. 7 illustrates the current frame 600, current block 602, reconstructed area 603, and reference block 604 of FIG. 6 with the addition of current block adjacent areas. The current block 602 has a height 750 and a width 752. The reference block has a height 770 and a width 772. Typically, the height and width of the current block 602 and reference block 604 will be the same. However, in some implementations, the height and width may be different (e.g., in which case, a prediction block for the current block may be determined, for example, by scaling the reference block).

The current block 602 has a current block adjacent area including a top portion 710 and left portion 720. The top portion 710 has a height 760 and the left portion has a width 762. The reference block 604 has a reference block adjacent area including a top portion 730 and a left portion 740. The top portion 730 has a height 780 and the left portion has a width 782. The height and width of respective portions of the current block adjacent area and the reference block adjacent area may be fixed or may change on a block, tile, frame, or other basis depending on the implementation. For example, in some implementations the respective heights and widths of the adjacent area portions may be 1 pixel. In some implementations, the respective heights and widths of the adjacent portions may be greater than 1 pixel. Depending on the implementation, the height and width of the portions may be the same or may be different.

As shown in FIG. 7, portions 710, 720, 730, and 740 include pixels that are spatially adjacent (e.g., next to) to their respective reference block or current block. In some implementations, a portion or adjacent area may be used that does not include pixels that are spatially adjacent to a reference block or current block (e.g., there may be a gap between pixels of a reference block adjacent area and pixels of a reference block).

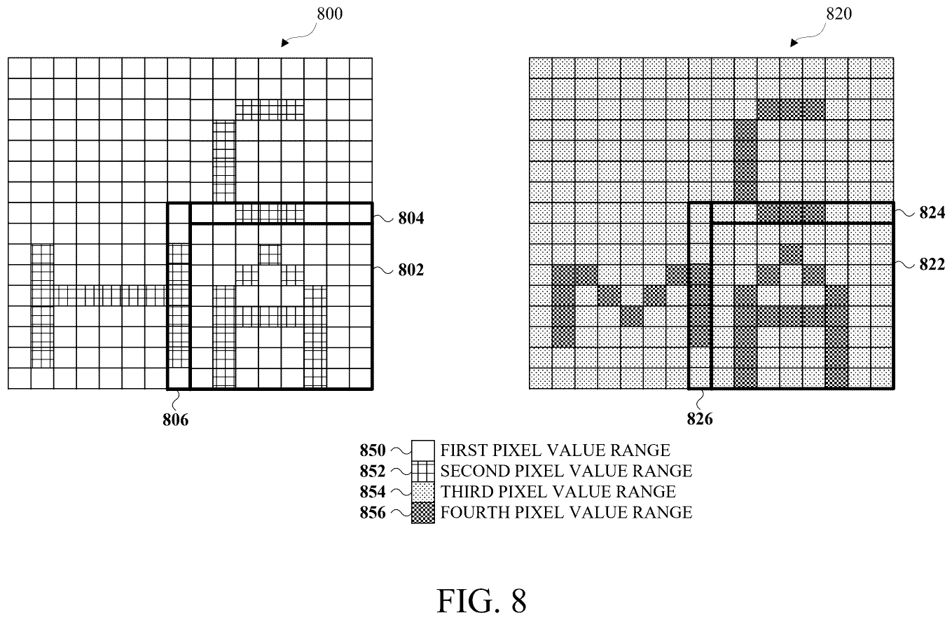

FIG. 8 is a block diagram illustrating an example of pixel values for which multimodal prediction may be used in accordance with implementations of this disclosure. FIG. 8 depicts an example of pixel values within certain areas of a frame. These pixel values are provided for example purposes only and different pixel values and combinations thereof may be utilized in implementations of this disclosure.

Reference area 800 illustrates pixels in a reference block 802, reference block adjacent area including top portion 804 and left portion 806, and pixels above and to the left of the reference block 802 and reference block adjacent area (for reader context). The reference block 802, reference block adjacent area, top portion 804, and left portion 806 may correspond to reference block 604, reference block adjacent area, top portion 730, and left portion 740 as described previously with respect to FIGS. 6 and 7.

Current area 820 shows pixels in a current block 822, current block adjacent area including top portion 824 and left portion 826, and pixels above and to the left of the current block 822 and current block adjacent area (for reader context). The current block 822, reference block adjacent area, top portion 824, and left portion 826 may correspond to current block 602, current block adjacent area, top portion 710, and left portion 720 as described previously with respect to FIGS. 6 and 7.

Reference area 800 includes pixels having values within a first pixel value range 850 and a second pixel value range 852. Current area 820 includes pixels having values within a third pixel value range 854 and a fourth pixel value range 856.

Aspects of implementations of multimodal prediction will now be described in the context of the previous drawings including FIGS. 6-8.

Multimodal prediction may include the following aspects: (1) use intra block copy to find the reference block, (2) identify current block adjacent area and reference block adjacent area, (3) classify pixels into different groups, and (4) derive a linear model for one or more groups and apply the linear model to pixels in the reference block to obtain prediction pixels for the current block. The prediction pixels may be organized into a prediction block used to predict the current block.

First, intra block copy may be utilized to identify a reference block for predicting the current block. This process may be done at either an encoder or decoder. At an encoder, a search may be performed to identify the reference block, the identification of which may be later encoded into a compressed bitstream using, e.g., a block vector. At a decoder, the identification of the reference block may be decoded from a compressed bitstream (e.g., to obtain a block vector) in order to identify the reference block.

Second, adjacent areas are identified. The reference block adjacent area and current block adjacent area may be identified as described in FIGS. 7 and/or 8. Depending on the implementation, other adjacent areas may be used, such as ones that have different heights and/or widths. In some implementations, the adjacent area(s) may only include pixels from a top portion (e.g., top portion 804 or top portion 824) or pixels from a left portion (e.g., left portion 806 or left portion 826). Such adjacent areas are not exhaustive and different adjacent areas may be defined and used. The encoder and decoder may utilize the same process to identify adjacent areas so that both encoder and decoder identify and utilize the same adjacent areas. Depending on the implementation, the adjacent area identification process may be fixed or dependent on information in the compressed bitstream. Depending on the implementation, the adjacent areas may include pixels adjoining pixels of the respective reference block or current block or may not include pixels adjoining pixels of the respective reference block or current block.

Third, the reference block and the adjacent areas are classified. Video signals often show different statistical properties due to the variety of video content. Sometimes pixels in a small neighborhood follow similar patterns while having a significant difference with other neighboring pixels. To capture such statistical properties, pixels may be classified into different groups.

Specifically, classification may be performed on three sets of pixels: pixels of the reference block (which may be referred to as S0), pixels of the reference block adjacent area (which may be referred to as S1), and pixels of the current block adjacent area (which may be referred to as S2). In some implementations, a histogram analysis, clustering algorithm, or combination thereof may be used to classify the pixels. Other classifying approaches may also be used.

After classification, the pixels in each of S0, S1, and S2 are classified into M groups. The value of M may be 2 or a greater number depending on the implementation. M may be fixed or may vary based on information included in the compressed bitstream.

The groups for each of S0, S1, and S2 may be ordered. The ordering of the groups may indicate an association between groups. For example, a first group of S0 may be associated with a first group of S1 and a first group of S2. Associated groups may include pixels that are deemed to be highly correlated. Depending on the implementation, different mechanisms of associations of groups may be used other than ordering.

Classification may also be described by the equation θ(p)=k, where θ is a classification process, p is a set of pixels (e.g., S0, S1, or S2), and k=∈{1,2, . . . , M}. Depending on the implementation, the classification process may be different for some or all the sets of pixels.

The example of FIG. 8 illustrates sets of pixel values where a bimodal classification (e.g., classification into two groups) may be utilized. In this example, pixels in the first pixel value range 850 may be classified into a first group of pixels for reference block 802 and pixels in the second pixel value range 852 may be classified into a second group of pixels for reference block 802. Pixels in the first pixel value range 850 may be classified into a first group of pixels for the reference block adjacent area (e.g., including top portion 804 and left portion 806) and pixels in the second pixel value range 852 may be classified into a second group of pixels for the reference block adjacent area (e.g., including top portion 804 and left portion 806). Pixels in the third pixel value range 854 may be classified into a first group of pixels for the current block adjacent area (e.g., including top portion 824 and left portion 826) and pixels in the fourth pixel value range 856 may be classified into a second group of pixels for the current block adjacent area (e.g., including top portion 824 and left portion 826). In the foregoing example, each of the first groups are correlated and each of the second groups are correlated.

In some implementations, classification may not be performed on the reference block adjacent area.

Fourth, a linear model is derived for one or more groups and applied to obtain prediction pixels for the current block. Reconstructed pixel values from the correlated groups (e.g., the first group as described above) of the adjacent areas (S1 and S2) may be used to derive a model to approximate a relationship between reference and current pixels.

For at least one or each of group k {1,2, . . . , M}, a separate model may be derived. For example, a linear model of the form Yk=ak*Xk+bk may be used. For a given group k, parameters (ak, bk) may be derived given that Xk is a vector of pixels from k group of set S1 and Y is a vector of pixels from k group of set S2. Depending on the implementation, a single model may be derived for more than one group of pixels, a different model may be derived for each of two or more groups of pixels, or combinations thereof.

Then, for a given pixel xi in S0, whose group ID is k, i.e., (xi)=k, the corresponding linear model is applied to generate the prediction pixel yi as follows: yi=ak*xi+bk. The value yi is the predicted pixel value of xi in the co-located position of the current block.

In some implementations, a different type of model may be used, for example, a non-linear model. Depending on the implementation, the same model may be used for each group, or different models may be used for different groups.

For example, a non-linear model Yk=ak*Xk*Xk+bk*Xk+ck could be used. For a given group k, parameters (ak, bk, ck) may be derived given that Xk is a vector of pixels from k group of set S1 and Yk is a vector of pixels from k group of set S2.

For example, a model could also be expressed in a more generalized form and written as Yk=F(Xk), where F is any function. One example is a 2D convolution, where Yk=Xk⊗H. In this example, His a convolution kernel, and ⊗ is the convolution operator.

A model using 2D convolution may also be written in the form

$$Y [ i , j ] = x [ i , j ] ⊗ h [ i , j ] = {\sum }_{m = - s}^{s} {\sum }_{n = - s}^{s} h [ m , n ] * x [ i - m , j - n ]$$

where [i,j] refers to a pixel location in a set of pixels, 2s+1 is the kernel size (width) of H, and Y and x refer to set S2 and S1, respectively. An example of h is:

| | | |
|---|---|---|
| 0 | 1 | 0 |
| 1 | 2 | 1 |
| 0 | 1 | 0 |

In implementations where classification is not performed for a reference block adjacent area, the model may be based on SO and S2 instead of S1 and S2 (e.g., X or Xk may refer to S0 instead of S1).

Information regarding the use of multimodal prediction may be encoded to or decoded from a compressed bitstream so that an encoder and decoder have sufficient information to execute the necessary processes to arrive at the same prediction result (e.g., via the same classification and model results). For example, an encoder may determine the value of the information in the encoding process and may encode such information in the compressed bitstream. For example, a decoder may decode such information from the compressed bitstream so that it is able to determine the process used by the encoder and can reproduce that process.

In some implementations, the compressed bitstream may include information indicating whether multimodal prediction is to be utilized in order to predict pixels.

In some implementations, a binary flag may be signaled at a sequence-level (e.g., bitstream, sequence of frames, frame) to indicate that multimodal prediction is available to be selected for that sequence. If multimodal prediction is indicated as not being available, multimodal prediction is not used for that sequence and no further information need be transmitted relating to multimodal prediction for that sequence.

If multimodal prediction is available (e.g., because of a sequence-level indication or because multimodal prediction is always available to be used), depending on the implementation, one or more of the following types of indicators may be included in the compressed bitstream at a current block level.

A first type of indicator is a binary flag that indicates whether multimodal prediction is used for a current block or not. In some implementations, multimodal prediction is only available for intra block copy coded blocks, and such a flag will only be included for blocks that are coded using intra block copy. In some implementations, multimodal prediction may be available for blocks predicted in other ways, and such a flag may be included when other prediction modes are used.

A second type of indicator is information about a number of groups to which the pixels of respective adjacent areas and/or reference block are classified into. For example, if there is a minimum number of groups of 2, then the number of groups used—2 can be signaled in the compressed bitstream. In implementations where the number of groups is fixed or is determined based on other contextual information in the compressed bitstream, this indicator would not be included in the compressed bitstream.

A third type of indicator is information about the model used. For example, if there are two possible models, a binary indicator may be coded to indicate which model to utilize. In some implementations, the model may be selectable on a per group basis and a binary indicator may be coded on an individual group basis. In some implementations more than two models may be available and a number identifying the model to be used may be coded (e.g., on a block basis or a group basis). In some implementations, the model is fixed or determined based on other contextual information in the compressed bitstream, and the third type is not coded into the compressed bitstream.

In some implementations, the second type of indicator or third type of indicator may be coded at a higher level than a current block level. For example, it may instead be coded for a certain portion of a frame, such as a tile, a frame level, or a sequence level if the information represented by the second and third types are consistently used throughout such portion of the video. In such cases, the second and third type information may be used only for such blocks for which multimodal prediction is indicated by the first type.

Depending on the implementation, multimodal prediction may be applied in different ways to different color channels (e.g., YUV or RGB). In some implementations, multimodal prediction is only applied to the luma channel (e.g., Y). In some implementations, multimodal prediction is applied to each luma (e.g., Y) and chroma channel (e.g., U, V) and classification and model derivation are performed separately for each channel. In some implementations, classification and model derivation are performed only for the luma channel and the resulting groups and models are applied to both luma and chroma channels. In some implementations, the process for using multimodal prediction with respect to different color channels is fixed and both the encoder and decoder are configured to utilize such process (e.g., no information indicating the process regarding color channels need be included in the compressed bitstream). In some implementations, the process for using multimodal prediction with respect to different color channels may be changeable and information may be included in the compressed bitstream indicating the process utilized.

Variations in the foregoing description of multimodal prediction are possible depending on the implementation. For example, although the foregoing description references the use of multimodal prediction with intra block copy prediction, multimodal prediction may also be used with other prediction methodologies, such as inter prediction, depending on the implementation. In some implementations, multimodal prediction may be applied to a constructed reference block including pixels that are generated from previously decoded pixels instead of a reference block including previously decoded pixels. For example, a constructed reference block may include pixels generated based on the output of an interpolation filter applied to previously decoded pixels. Multimodal prediction may then be applied to such generated pixels in the constructed reference block (and/or generated pixels in one or more of the adjacent areas) instead of previously decoded pixels.

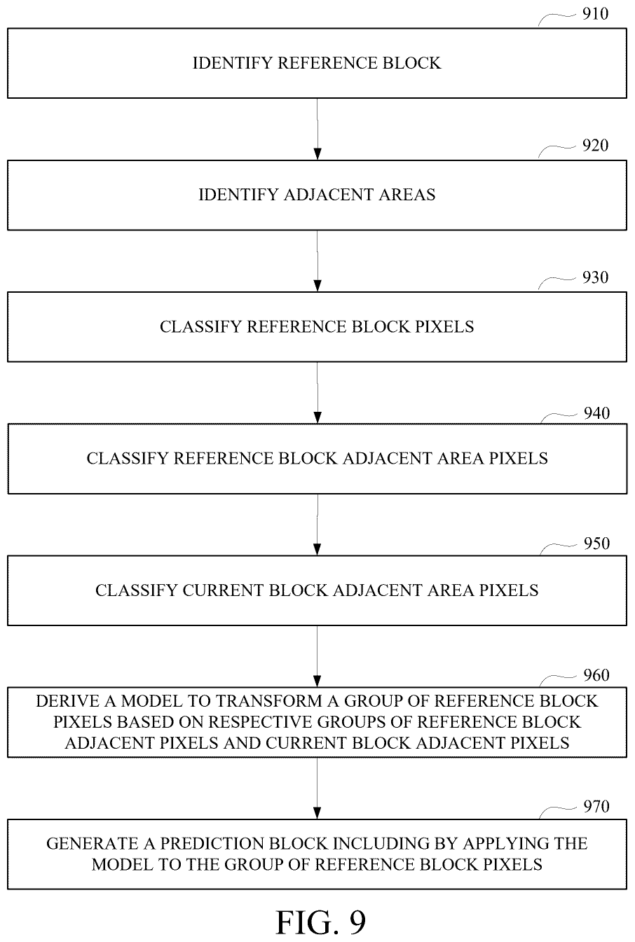

FIG. 9 is a flow diagram of an example technique 900 for predicting pixels in accordance with implementations of this disclosure. In some implementations, technique 900 may be performed using a computing device 100, a computing system 200, an encoder 400, a decoder 500, or combinations thereof. In some implementations, technique 900 may be implemented based on or using aspects of the disclosure described above including with respect to FIGS. 6-8. In some implementations, example technique 900 is, in whole or part, implemented in instructions stored on a computer-readable medium that, when executed by a processor cause the processor to perform steps of example technique 900. In some implementations, a computer-readable medium stores a compressed bitstream that is encoded by or decodable using steps of example technique 900.

At step 910, a reference block is identified. For example, in an encoder, a search may be performed to identify a reference block of previously decoded pixels in the same frame or a different frame that has similarities to a current block. For example, in a decoder, a compressed bitstream may include information identifying a reference block of previously decoded pixels for a current block, such as by way of a block vector or motion vector. The decoder may thus identify the reference block by decoding and using such information to identify the reference block. In some implementations the identified reference block may include generated pixels (e.g., such as by applying a filter to previously decoded pixels) instead of previously decoded pixels. Reference blocks and identification of reference blocks are further described above.

At step 920, adjacent areas are identified. For example, a reference block adjacent area and a current block adjacent area are identified. Such adjacent areas may be as described above, for example with respect to FIG. 7 or 8. In some implementations, a reference block adjacent area may not be utilized and thus may not be identified. Adjacent areas and their identification are further described above.

At step 930, reference block pixels are classified. For example, reference block pixels may be classified using a classification process to group the pixels of the reference block into two or more groups of pixels, such as described above with respect to FIG. 8.

At step 940, reference block adjacent area pixels are classified. For example, pixels in the reference block adjacent area may be classified using a classification process to group the pixels of the reference block adjacent area into two or more groups of pixels, such as described above with respect to FIG. 8. In some implementations, the reference block adjacent area may not be utilized, and step 940 may be omitted.

At step 950, current block adjacent area pixels are classified. For example, pixels in the current block adjacent area may be classified using a classification process to group the pixels of the current block adjacent area into two or more groups of pixels, such as described above with respect to FIG. 8.

At step 960, a model is derived to transform a group of reference block pixels based on pixels in respective groups of reference block adjacent area pixels and current block adjacent area pixels. For example, a linear model may be fit based on differences between reference block adjacent area pixels and current block adjacent area pixels. In some implementations, a different type of model may be used, such as a non-linear model. Step 960 may include deriving a single model or more than one model. Depending on the implementation, models may be derived separately for different groups, a model may be derived based on pixels of multiple groups, a model may not be derived for a group, or combinations thereof. Derivation of models is further described above including with respect to FIG. 8.

At step 970, a prediction block is generated including by applying the model to pixels in the reference block to which the model corresponds. Step 970 may include applying models to more than one group of pixels. For example, a model may be applied to pixels in a group for which the model was derived. In some implementations, a model may be applied to pixels in a different group from which the model was derived. In some implementations, a model may be derived based on pixels from multiple groups and may be applied to none, some, or all of the groups of pixels from which it was derived. In some implementations, no model is applied to one or more groups. Generation of prediction blocks (e.g., which includes prediction pixels) including by applying a model to reference block pixels is further described above including with respect to FIG. 8.

Technique 900 may vary depending on the implementation. For example, in some implementations, steps 910 and/or 920 may be omitted if the reference block and/or adjacent areas have already been identified or are otherwise already known to the encoder and/or decoder. For example, in some implementations, steps 930, 940, and 950 may be combined in whole or part, for example, if the same classification process is used for two or more of the reference block, reference block adjacent area, and current block adjacent area.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc., stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product or compressed bitstream accessible from, for example, a tangible non-transitory computer-usable or computer-readable medium. A computer-usable or computer-readable medium can be any device that can, for example, tangibly contain, store, communicate, or transport the program or compressed bitstream for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g., disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method for predicting pixels of a current block, the method comprising:
classifying pixels of a reference block into a first plurality of groups;
classifying pixels of a current block adjacent area into a second plurality of groups;
deriving a first model for transforming a first group of the first plurality of groups based on pixels in a first group of the first plurality of groups and pixels in a first group of the second plurality of groups; and
generating a prediction block for the current block, wherein generating the prediction block includes applying the first model to pixels in the first group of the first plurality of groups.

2. The method of claim 1, further comprising classifying pixels of a reference block adjacent area into a third plurality of groups,
wherein deriving the first model for transforming the first group of the first plurality of groups is also based on pixels in a first group of the third plurality of groups.

3. The method of claim 2, wherein the first plurality of groups, the second plurality of groups, and the third plurality of groups each have a same number of groups and an ordering of groups such that groups of the first plurality of groups, the second plurality of groups, and the third plurality of groups are correlated based on their respective order in the ordering of groups.

4. The method of claim 2, wherein a same classification process is used for each of classifying pixels into the first plurality of groups, the second plurality of groups, and the third plurality of groups.

5. The method of claim 2, wherein a first classification process is used for classifying a first one of the first plurality of groups, the second plurality of groups, and the third plurality of groups and a second classification process is used for classifying a second one of the first plurality of groups, the second plurality of groups, and the third plurality of groups.

6. The method of claim 2, further comprising:
deriving a second model for transforming a second group of the third plurality of groups based on pixels in a second group of the first plurality of groups and pixels in a second group of the second plurality of groups,
wherein generating the prediction block also includes applying the second model to the second group of the third plurality of groups.

7. The method of claim 2, wherein the reference block adjacent area includes spatially adjacent pixels above the reference block and the current block adjacent area includes spatially adjacent pixels above the current block.

8. The method of claim 2, wherein the reference block adjacent area includes spatially adjacent pixels to a left side of the reference block and the current block adjacent area includes spatially adjacent pixels to the left side of the current block.

9. The method of claim 1, wherein the first model is a linear model, a non-linear model, or is implemented using a 2D convolution kernel.

10. The method of claim 1, further comprising identifying the reference block using an intra block copy mode.

11. The method of claim 1, wherein classifying pixels of the reference block, classifying pixels of the current block adjacent area, deriving the first model, and generating the prediction block are performed separately for luma and chroma channels of the current block.

12. The method of claim 1, wherein classifying pixels of the reference block, classifying pixels of the current block adjacent area, and deriving the first model are performed for a luma channel of the current block and generating the prediction block is performed separately for luma and chroma channels of the current block based on the first model derived for the luma channel.

13. The method of claim 1, further comprising:
encoding the current block into a compressed bitstream including encoding a binary indication that the current block was encoded using the method.

14. The method of claim 13, wherein encoding the current block into the compressed bitstream includes encoding an indication of a technique used to derive the first model or an indication of a number of groups in the first plurality of groups and the second plurality of groups.

15. The method of claim 1, further comprising:
decoding, from a compressed bitstream, a binary indication that the current block was encoded using the method.

16. The method of claim 15, further comprising:
decoding, from the compressed bitstream, an indication of a technique used to derive the first model or an indication of a number of groups in the first plurality of groups and the second plurality of groups.

17. A non-transitory computer-readable medium storing instructions, that when executed by a computer, cause the computer to predict pixels of a current block by:
classifying pixels of a reference block into a first plurality of groups;
classifying pixels of a current block adjacent area into a second plurality of groups;
deriving a first model for transforming a first group of the first plurality of groups based on pixels in a first group of the first plurality of groups and pixels in a first group of the second plurality of groups; and
generating a prediction block for the current block, wherein generating the prediction block includes applying the first model to pixels in the first group of the first plurality of groups.

18. The non-transitory computer-readable medium of claim 17, further comprising instructions, that when executed by a computer, cause the computer to predict pixels of the current block by classifying pixels of a reference block adjacent area into a third plurality of groups, wherein deriving the first model for transforming the first group of the first plurality of groups is also based on pixels in a first group of the third plurality of groups.

19. A non-transitory computer-readable medium storing a compressed bitstream encoded by an encoder or decodable by a decoder that predicts pixels of a current block encoded in the compressed bitstream by:
classifying pixels of a reference block into a first plurality of groups;
classifying pixels of a current block adjacent area into a second plurality of groups;
deriving a first model for transforming a first group of the first plurality of groups based on pixels in a first group of the first plurality of groups and pixels in a first group of the second plurality of groups; and
generating a prediction block for the current block, wherein generating the prediction block includes applying the first model to pixels in the first group of the first plurality of groups.

20. The non-transitory computer-readable medium of claim 19, wherein the pixels of a current block encoded in the compressed bitstream are further predicted by: classifying pixels of a reference block adjacent area into a third plurality of groups, wherein deriving the first model for transforming the first group of the first plurality of groups is also based on pixels in a first group of the third plurality of groups.
